(19) United States
(12) Patent Application Publication
(10) Pub. No.: US 2002/0043803 A1
(43) Pub. Date: Apr. 18, 2002

(54) Swivel connector

(76) Inventor: Michael Clemens Kietzmann, Deneysville (ZA)

Correspondence Address: ROCKEY, MILNAMOW & KATZ, LTD., TWO PRUDENTIAL PLAZA, STE. 4700, 180 NORTH STETSON AVENUE, CHICAGO, IL, 60601, US

(21) Appl. No.: 09/945,502

(22) Filed: Aug. 30, 2001

(30) Foreign Application Priority Data
Aug. 31, 2000 (ZA) 2000/4130

(51) Int. Cl. F16L 27/00

(52) U.S. Cl. 285/276

(57) ABSTRACT

This invention relates to a conduit swivel connector. The connector includes concentric, aligned outer and inner races and a plurality of bearing elements contained in an annular roller track defined between the races. The bearing elements hold the outer and inner races captive while allowing them to be freely, relatively rollable. A first tubular connecting stub is fast with the outer race and provides a first connector for connection to a conduit, and a second tubular connecting stub is fast with the inner race and provides a second connector for connecting to a conduit. The connector includes an integral cover which is received over the outer race, and an inner liner extending substantially through the connecting stubs. The invention extends to a pool cleaner, to a pump suction line for a pool cleaner installation, and also to a pool cleaner installation.

THIS INVENTION relates to a connector. It more particularly relates to a conduit swivel connector. It also relates to a pool cleaner and to a pool pump suction line.

In accordance with a first aspect of the invention, there is provided a conduit swivel connector which includes

concentric, aligned outer and inner races and a plurality of bearing elements contained in an annular roller track defined between the outer and inner races, the bearing elements holding the outer and inner races captive while allowing the outer and inner races to be freely, relatively rollable;

a first tubular connecting stub fast with the outer race and providing a first connector for connection to a conduit; and

a second tubular connecting stub fast with the inner race and providing a second connector for connection to a conduit.

Said outer and inner races and said first and second connecting stubs may be of synthetic polymeric material.

Said bearing elements may be of synthetic polymeric material.

Said outer race and said first connecting stub may be integral, and said inner race and said second connecting stub may be integral.

Said integral outer race and first connecting stub may have a solid side wall forming a solid annular connecting formation between the outer race which is of relatively larger diameter and the first connecting stub which is of relatively smaller diameter. The solid annular connecting formation may close a first side of the annular roller track. The swivel connector may include an integral cover comprising a rim and a solid, annular side. The rim may be frictionally received over said outer race and the solid, annular side may cover a second side opposed to said first side of the annular roller track. The solid, annular side may have an inner periphery allowing it to fit snugly without touching over the second connecting stub.

The first and second connecting stubs may be aligned and may provide spigots for receipt within end portions of said conduits. The spigots may be of equal outer diameter.

The connector may include an inner liner extending substantially through the connecting stubs. The inner liner may be secured to one of the first and second connecting stubs and may be snugly, rotatably received within the other of the first and second connecting stubs.

The swivel connector may be intended to conduct flow in a predetermined direction. Said liner may be secured to an upstream one of said first and second connecting stubs.

In accordance with a second aspect of the invention, there is provided a pool cleaner which includes a conduit swivel connector in accordance with the first aspect of the invention operatively mounted in a suction line of the pool cleaner.

In accordance with a third aspect of the invention, there is provided a pump suction line for a pool cleaner installation, which includes a conduit swivel connector in accordance with the first aspect of the invention.

In accordance with a fourth aspect of the invention, there is provided a pool cleaner installation which includes a pool cleaner and a suction line, and a conduit swivel connector in accordance with the first aspect of the invention, in which the swivel connector may form a direct swivellable connection between the pool cleaner and the suction line.

In accordance with a fifth aspect of the invention, there is provided a pool cleaner installation which includes a pool cleaner, a suction line connector in a weir, and a suction line for connecting the pool cleaner to the suction line, the pool cleaner installation including a conduit swivel connector in accordance with the first aspect of the invention forming a swivellable connection between the suction line and the suction line connector in the weir.

The invention is now described, by way of examples, with reference to the accompanying diagrammatic drawings.

In the drawings,

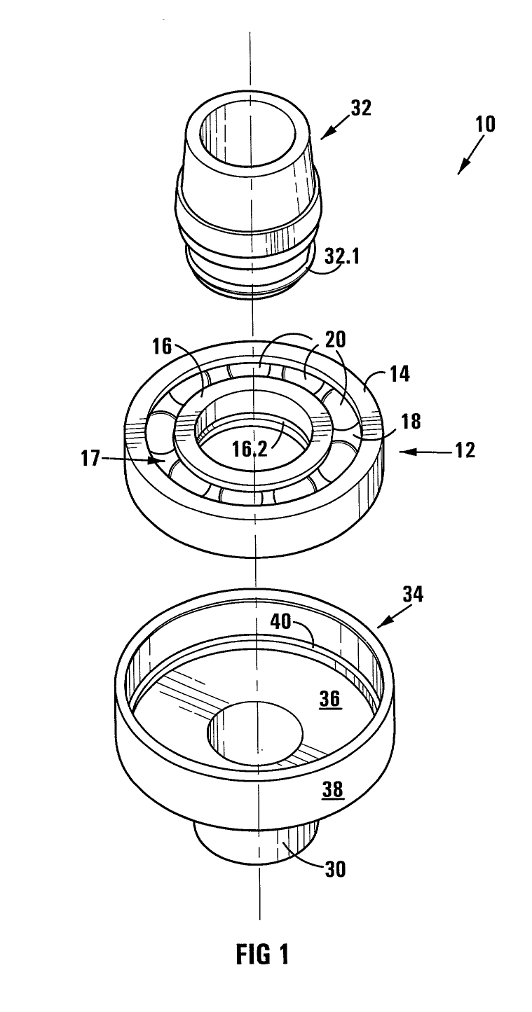

FIG. 1 shows an exploded three-dimensional view of a first embodiment of a conduit swivel connector in accordance with the invention;

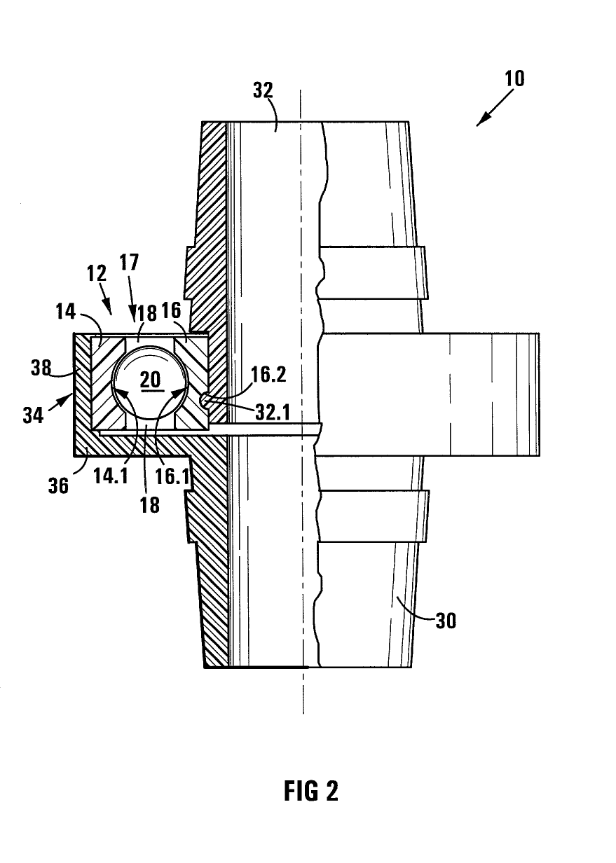

FIG. 2. shows an axial part sectional view through the swivel connector of FIG. 1;

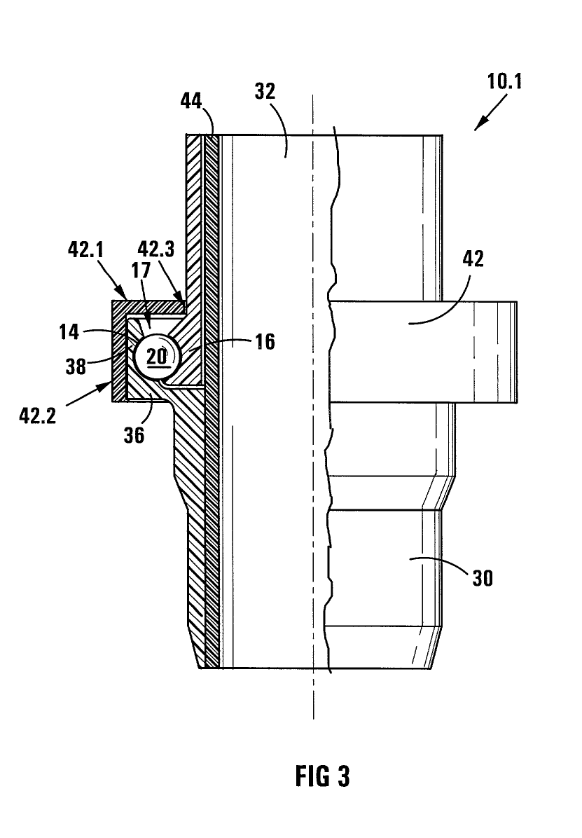

FIG. 3 shows an exploded three-dimensional view of a second embodiment of a conduit swivel connector in accordance with the invention;

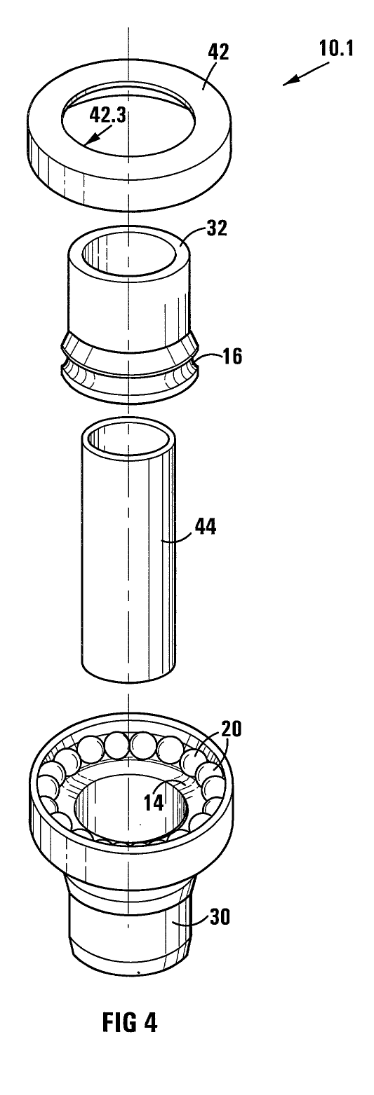

FIG. 4 shows an axial part sectional view through the swivel connector of FIG. 3;

FIG. 5 shows a schematic drawing of a conduit swivel connector, in accordance with the invention, forming a direct connection in a pump suction line of a pool cleaner installation between a pool cleaner and a suction line; and

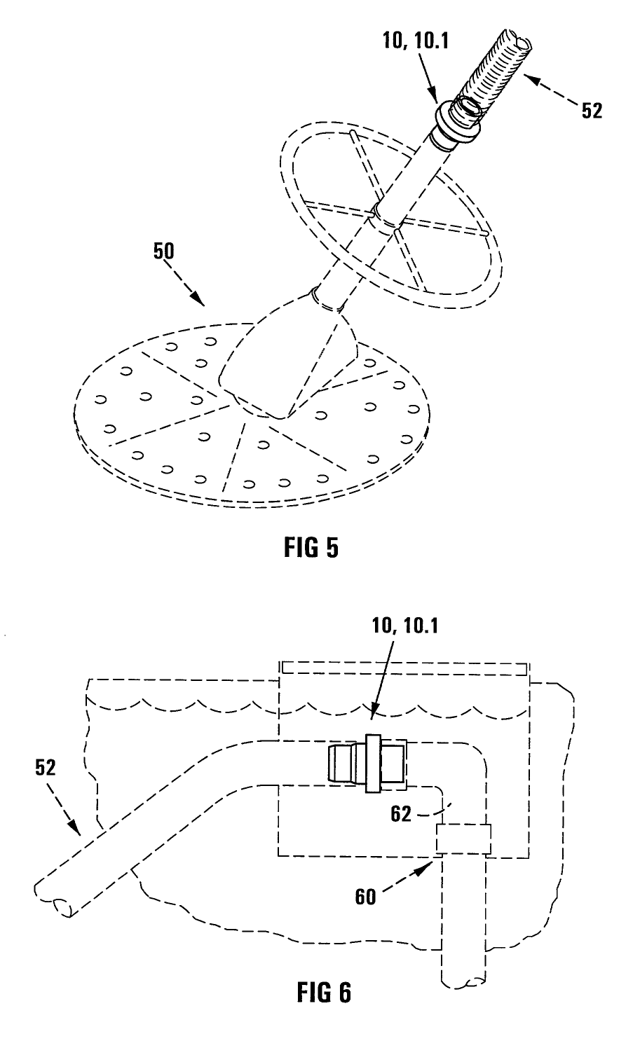

FIG. 6 shows a schematic drawing of a conduit swivel connector, in accordance with the invention, forming a connection, in a pump suction line of a pool cleaner installation, between a suction line and a suction line connector in a weir.

Referring to FIGS. 1 and 2 of the drawings, reference numeral 10 generally indicates a conduit swivel connector in accordance with the invention. The connector 10 includes a bearing unit 12 comprising a bearing housing defined by radially spaced, concentric outer and inner races 14 and 16 respectively. The races 14, 16 have peripherally grooved surfaces 14.1 and 16.1, respectively, which are radially aligned and opposed, and define between them an annular roller track, generally indicated by reference numeral 17. A bearing separator or cage 18 containing a plurality of bearing elements in the form of spherical balls 20 is located within the annular roller track 17. The balls 20 in the cage 18 make rolling contact with the races 14, 16 and allow them to be freely, relative rollable, i.e. allow swivelling of the races 14, 16.

The connector 10 includes a first tubular connecting stub 30 and a second tubular connecting stub 32 which are mounted to the races 14, 16, respectively.

The tubular connecting stub 32 is press-fitted into the inner race 16 and is secured therein by means of a locking formation defined by an annular ridge 32.1 which is received tongue and groove fashion in a complementary groove 16.2 formed in the inner race 16.

The tubular connecting stub 30 has a cup formation 34 integrally formed at an end thereof. The cup formation 34 is defined by a solid annular side 36 and a rim 38 standing longitudinally proud of the side 36. The bearing unit 12 and more specifically the outer race 14 is press-fitted into the cup formation 34 and seats against a circular lip 40 which extends radially inwardly from the rim 38 adjacent the side 36, thereby locating the bearing unit 12 axially within the cup formation 34. It will be appreciated that the swivelling between the races 14, 16 is improved as the inner race 16 is spaced from the side 36, i.e. it is not in (frictional) contact therewith.

The tubular connecting stubs 30, 32 respectively provide first and second connectors whereby they are connectable spigot and socket fashion to end portions of two conduit sections.

Referring to FIGS. 3 and 4 of the drawings, reference numeral 10.1 indicates a second embodiment of a conduit swivel connector in accordance with the invention. The connector 10.1 resembles the connector 10, and, accordingly, like reference numerals are used to indicate like parts or features.

The connector 10.1 includes concentric, aligned outer and inner races 14 and 16 respectively. The races 14, 16 are of synthetic polymeric material. The races 14, 16 define between them an annular roller track 17 in which a plurality of bearing elements in the form of spherical balls 20 of synthetic polymeric material are contained. The spherical balls 20 hold the outer and inner races 14, 16 captive while allowing them to be freely, relatively rollable.

The connector 10.1 includes first and second aligned tubular connecting stubs 30, 32 integral with the outer and inner races 14, 16 respectively. The connecting stubs 30, 32 protrude axially from opposing sides of the races 14, 16, and respectively provide first and second connectors for connection to end portions of conduits.

The outer race 14 has a larger diameter than the first connecting stub 30, and has a solid side wall 36 which forms a solid annular connection between the race 14 and the stub 30. The side wall 36 closes a first side of the annular roller track 17.

The connector 10.1 includes a cover 42 which is frictionally received over the outer race 14, and covers a second side of the annular roller track 17. The cover 42 has a solid annular side 42.1 and a rim 42.2 standing longitudinally proud of the side 42.1. The rim 42.2 is frictionally held over the outer race 14. The side 42.1 has an inner periphery 42.3 allowing it to fit snugly without touching over the second connecting stub 32.

The connector 10.1 further includes a tubular inner liner 44 extending through the connecting stubs 30, 32. The liner 44 is secured to the first connecting stub 30, and is snugly, rotatably received within the second connecting stub 32. Typically, the liner 44 is press fitted into the first connecting stub 30. The connector 10.1 is intended to conduct flow in a predetermined direction, and, in use, is connected to the conduit so that the first connecting stub 30 is in an upstream position. The liner 44 thus inhibits leakage through the annular roller track 17. The connecting stubs 30, 32 are frictionally received within sockets, e.g. end portions of hoses, spigot-socket fashion.

Referring now to FIG. 5 of the drawings, it will be seen that the connector 10, 10.1 may be used to form a swivel connection in a pool suction line, between a conventional pool cleaner, indicated generally by reference numeral 50 (and which is not further described) and hosing 52 forming part of a suction line.

As can be seen from FIG. 6 of the drawings, the connector 10, 10.1 may also be used, in a pool pump suction line, to form a swivel connection between hosing 52 connecting a pool cleaner (not shown in FIG. 6 of the drawings) and an outlet 60 of a pool leading to a pump (not shown) in the suction line. In this case, an elbow connecting piece 62 is fitted between the outlet 60 and the connector 10, 10.1 to facilitate swivelling of the connector 10, 10.1.

The Inventor has found that conduit swivel joints used in swimming pools to form a swivel connection in a pool pump suction line do not provide effective swivel action or provide no swivel action because of friction between the components intended to swivel. As a result movement of the pool cleaner to certain areas of the pool is restricted and these areas are consequently not cleaned.

The Inventor believes that it is an advantage of the invention that it provides a conduit swivel connector which can be used in swimming pools and which provides effective swivel action.

1. A conduit swivel connector which includes
concentric, aligned outer and inner races and a plurality of bearing elements contained in an annular roller track defined between the outer and inner races, the bearing elements holding the outer and inner races captive while allowing the outer and inner races to be freely, relatively rollable;
a first tubular connecting stub fast with the outer race and providing a first connector for connection to a conduit; and
a second tubular connecting stub fast with the inner race and providing a second connector for connection to a conduit.

2. A swivel connector as claimed in claim 1, in which said outer and inner races and said first and second connecting stubs are of synthetic polymeric material.

3. A swivel connector as claimed in claim 2, in which said bearing elements are of synthetic polymeric material.

4. A swivel connector as claimed in claim 2, in which said outer race and said first connecting stub are integral, and said inner race and said second connecting stub are integral.

5. A swivel connector as claimed in claim 4, in which said integral outer race and first connecting stub has a solid side wall forming a solid annular connecting formation between the outer race which is of relatively larger diameter and the first connecting stub which is of relatively smaller diameter, the solid annular connecting formation closing a first side of the annular roller track, the swivel connector including an integral cover comprising a rim and a solid, annular side, the rim being frictionally received over said outer race and the solid, annular side covering a second side opposed to said first side of the annular roller track, the solid, annular side having an inner periphery allowing it to fit snugly without touching over the second connecting stub.

6. A swivel connector as claimed in claim 1, in which the first and second connecting stubs are aligned and provide spigots for receipt within end portions of said conduits.

7. A swivel connector as claimed in claim 6, in which the spigots are of equal outer diameter.

8. A swivel connector as claimed in claim 6, which includes an inner liner extending substantially through the connecting stubs.

9. A swivel connector as claimed in claim 8, in which the inner liner is secured to one of the first and second connecting stubs and is snugly, rotatably received within the other of the first and second connecting stubs.

10. A swivel connector as claimed in claim 9, which is intended to conduct flow in a predetermined direction, said liner being secured to an upstream one of said first and second connecting stubs.

11. A pool cleaner which includes a conduit swivel connector as claimed in claim 1 operatively mounted in a suction line of the pool cleaner.

12. A pump suction line for a pool cleaner installation, which includes a conduit swivel connector as claimed claim 1.

13. A pool cleaner installation which includes a pool cleaner and a suction line, and a conduit swivel connector as claimed in claim 1, in which the swivel connector forms a direct swivellable connection between the pool cleaner and the suction line.

14. A pool cleaner installation which includes a pool cleaner, a suction line connector in a weir, and a suction line for connecting the pool cleaner to the suction line, the pool cleaner installation including a conduit swivel connector as claimed in claim 1 forming a swivellable connection between the suction line and the suction line connector in the weir.
